(19) United States
(12) Patent Application Publication
(10) Pub. No.: US 2017/0183977 A1
(43) Pub. Date: Jun. 29, 2017

(54) STEAM TURBINE SYSTEM AND ASSOCIATED METHOD FOR PRESERVING A STEAM TURBINE SYSTEM

(71) Applicant: SIEMENS AKTIENGESELLSCHAFT, MÜNCHEN (DE)

(72) Inventors: Kai Brune, Rheinberg (DE); Stefan Brußk, Mülheim an der Ruhr (DE); Nigel-Philip Cox, Mülheim an der Ruhr (DE); Daniel Dreier, Essen (DE); Tobias Gabl-Zimmek, Essen (DE); Andrei Ghicov, Mülheim an der Ruhr (DE); Marie Hu, Mülheim an der Ruhr (DE); Mario Koebe, Mülheim an der Ruhr (DE); Marc Lange, Köln (DE); Teresa Pott, Mülheim (DE); Stefan Riemann, Kaarst (DE); Andreas Ulma, Mülheim an der Ruhr (DE); David Veltmann, Essen (DE); Gerta Zimmer, Mülheim an der Ruhr (DE)

(21) Appl. No.: 15/312,697

(22) PCT Filed: Mar. 31, 2015
(86) PCT No.: PCT/EP2015/057029

§ 371 Date: Nov. 21, 2016

(30) Foreign Application Priority Data
May 28, 2014 (DE) 102014210225.1

(51) Int. Cl. F01D 25/00; F01K 13/02

(52) U.S. Cl. CPC F01D 25/007; F01K 13/02; F05D 2220/31; F05D 2260/608; F05D 2260/95

(57) ABSTRACT

A steam turbine system including a steam turbine which has a turbine housing and at least one turbine shaft accommodated in the turbine housing and sealed by seals, a condenser connected fluidically to the steam turbine, an evacuation unit connected fluidically to the condenser, and a dry air source which is connected fluidically to the steam turbine, wherein the steam turbine system is designed in such a way that the evacuation unit is optionally fluidically connectable to the dry air source. A method for preserving components of a steam turbine system to prevent idle-state corrosion is also provided, which the steps: shutting down a steam turbine of the steam turbine system and sucking dry air into the steam turbine using an evacuation unit which additionally functions during intended operation of the steam turbine to exhaust a resulting amount of gas into a condenser.

### CROSS-REFERENCE TO RELATED APPLICATIONS

This application claims priority to PCT Application No. PCT/EP2015/057029, having a filing date of Mar. 31, 2015, based off of German application No. DE 102014210225.1 having a filing date of May 28, 2014, the entire contents of which are hereby incorporated by reference.

### FIELD OF TECHNOLOGY

The following relates to a steam turbine system comprising a steam turbine, which has a turbine housing and a turbine shaft, which is accommodated in the turbine housing and sealed by means of seals with respect to this steam turbine, a condenser, which is fluidically connected to the steam turbine, an evacuation unit, which is fluidically connected to the condenser, and a dry air source, which is fluidically connected to the steam turbine.

### BACKGROUND

Steam turbine systems are known in various configurations in the prior art. They comprise a steam turbine, which is often divided into a number of turbine stages. Thus, for example, a high-pressure stage, a medium-pressure stage and a low-pressure stage may be provided. During the operation of the steam turbine system, heated steam is fed to the steam turbine and expanded in it. Thermal energy is thereby converted into mechanical energy, which is used for driving a load, such as for example a generator.

Normally connected to the steam turbine is a condenser, which condenses the steam emerging from the steam turbine. Connected in turn to the condenser is an evacuation unit, which serves the purpose of extracting the amount of gas occurring in the condenser. Thus, an evacuation unit may for example have one or more evacuation pumps.

When running down a steam turbine, the steam remaining in the steam turbine condenses as soon as the temperature goes below the dew point. Moreover, moist air and oxygen from the surroundings penetrate through the seals into the interior of the steam turbine, which during operation is prevented for example by a sealing steam system. This results in the risk of downtime corrosion of metal components arranged in the interior of the steam turbine. Turbine housings, valve housings, condensers and the like are affected by this in particular.

To avoid downtime corrosion during prolonged downtimes of a steam turbine system, it is already known to connect to the steam turbine external dry air devices, which dry air from the surroundings and then introduce it continuously into the turbine housing. The dry air introduced takes up moisture from the interior of the turbine housing and from the condenser and leaves again at defined openings in the turbine housing. In this way, downtime corrosion is effectively counteracted. However, the connecting of the dry air devices entails great additional effort.

### SUMMARY

An aspect relates to providing an alternative steam turbine system of the type mentioned at the beginning and an alternative method for preserving components of a steam turbine with which downtime corrosion of metal components of the steam turbine after shutting down can be ensured inexpensively, reliably and without great additional effort.

A further aspect relates to providing a steam turbine system of the type mentioned at the beginning which is characterized in that the steam turbine system is designed such that the evacuation unit can optionally be fluidically connected to the dry air source. Consequently, the evacuation unit, which during operation of the steam turbine as intended serves the purpose of extracting the amount of gas occurring in the condenser, assumes the function when the steam turbine is shut down of sucking dry air out of the dry air source and passing it through the interior of the steam turbine system in order to take up and carry away condensate occurring there. In this way, a means of supplying dry air that can be automated is made available, using the evacuation unit that is already present in conventional steam turbine systems for delivering the dry air. Moreover, downtime corrosion can be counteracted easily and without great effort.

According to one configuration of embodiments of the present invention, a sealing steam unit is provided, designed such that sealing steam can optionally be applied to the steam turbine in the region of the seals. By using the sealing steam, steam leaving the steam turbine during operation of the steam turbine system as intended can be prevented from escaping through the seals.

Advantageously, the dry air source and the sealing steam unit are connected to the steam turbine by way of a common system of lines, at least one valve being provided, designed such that the steam turbine can optionally be fluidically connected to the sealing steam unit or to the dry air source. In other words, the evacuation unit is preferably connected to an already existing system of lines of the sealing steam unit, which brings about a simplified structure and a start-up procedure that can be automated.

A further aspect relates to providing a method for preserving components of a steam turbine system, in particular a steam turbine system according to embodiments of the invention, which comprises the steps of: running down the steam turbine and sucking in dry air by using an evacuation unit which, during operation of the steam turbine as intended, serves the purpose of extracting an amount of gas occurring in a condenser.

Preferably, during the shutting down of the steam turbine, a supply of sealing steam taking place by way of a system of lines is interrupted, whereupon dry air is sucked in by way of the system of lines.

### BRIEF DESCRIPTION

Some of the embodiments will be described in detail, with reference to the following figures, wherein like designations denote like members, wherein:

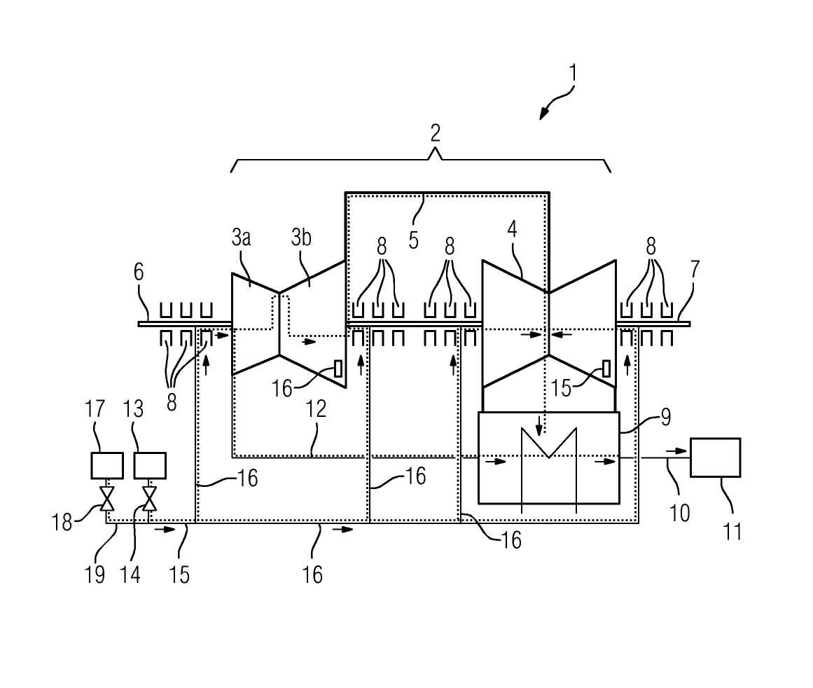

FIG. 1 depicts a schematic view of an embodiment of a steam turbine system.

### DETAILED DESCRIPTION

The steam turbine system 1 comprises a steam turbine 2 with a high-pressure stage 3a and a medium-pressure stage 3b and also a low-pressure stage 4, which are connected to one another by way of an overflow line 5. The high-pressure and medium-pressure stages 3a, 3b and the low-pressure stage 4 have in each case a turbine shaft 6, 7, the turbine shafts 6, 7 being mounted in a common housing or in housings that are separate from one another (not represented any more specifically) and are sealed in a known way by means of seals 8.

The steam turbine system 1 also comprises a condenser 9, which is fluidically connected to the low-pressure stage 4 and to which an evacuation unit 11 is connected by way of a connection line 10. In addition, the condenser 9 is connected by way of a discharge line 12 to the high-pressure stage 3a and the low-pressure stage 4.

A further component part of the steam turbine system 1 is formed by a sealing steam unit 13, which is fluidically connected to the interior of the high-pressure stage 3a and the medium-pressure stage 3b and also the low-pressure stage 4. To be more specific, the connection of the sealing steam unit 13 takes place by way of a system of sealing steam lines, which comprises a connection line 15 provided with a shut-off valve 14 and, branching off from this line, manifold lines 16, which are connected between the seals 8 to the high-pressure stage 3a and the medium-pressure stage 3b and also the low-pressure stage 4.

The steam turbine system 1 also comprises a dry air source 17, which is connected by way of a dry air line 19 provided with a shut-off valve 18 to the connection line 15 of the system of sealing steam lines at a position between the shut-off valve 14 and the manifold lines 16.

During operation of the steam turbine system 1 as intended, steam generated in a steam generator is passed in a known way through the steam turbine 2 and subsequently condensed in the condenser 9, the amount of gas occurring in the condenser 9 being extracted by means of the evacuation unit 12. During operation as intended, by using the sealing steam unit 13 sealing steam is applied to the high-pressure stage 3a and the medium-pressure stage 3b and also the low-pressure stage 4 in the region of the seals 8 in order to prevent the process steam from escaping or ambient air from forcing its way in.

During the shutting down of the steam turbine system 1, the supply of sealing steam is interrupted by closing the shut-off valve 14. Furthermore, the shut-off valve 18 of the dry air line 19 is opened, so that then, as indicated in the drawing by the dashed lines, instead of sealing steam dry air is sucked out of the dry air source 17 by the steam turbine system 1 in the direction of the condenser 9 by the evacuation unit 11 fluidically connected to the dry air source. The dry air flows through the connection line 15 into the manifold lines 16 and, in the region of the seals 8, enters the high-pressure stage 3a and the medium-pressure stage 3b and also the low-pressure stage 4, from where it goes into the condenser 9 and is extracted by way of the evacuation unit 12. The dry air picks up the moisture present in the steam turbine system 1 and carries it away. Correspondingly, components of the steam turbine system 1 that are susceptible to corrosion are effectively protected from downtime corrosion.

Although the invention has been more specifically illustrated and described in detail by the preferred exemplary embodiment, the invention is not restricted by the disclosed examples and other variations can be derived herefrom by a person skilled in the art without departing from the scope of protection of the invention.

1-5. (canceled)

6. A steam turbine system comprising:
a steam turbine, which has a turbine housing and at least one turbine shaft, which is accommodated in the turbine housing and sealed by means of seals with respect to the steam turbine;
a condenser, which is fluidically connected to the steam turbine;
an evacuation unit, which is fluidically connected to the condenser; and
a dry air source, which is fluidically connected to the steam turbine, in which the steam turbine system is designed such that:
the evacuation unit is fluidically connected to the dry air source, in which a sealing steam unit is provided,
the sealing steam is applied to the steam turbine in a region of the seals, in which the dry air source and the sealing steam unit are connected to the steam turbine by way of a common system of lines, at least one valve being provided, and
the steam turbine is fluidically connected to the sealing steam unit or to the dry air source.

7. A method for preserving components of a steam turbine system to avoid downtime corrosion of a steam turbine system as claimed in claim 6, which comprises the steps of: running down the steam turbine of the steam turbine system; and sucking dry air into the steam turbine by using an evacuation unit which, during operation of the steam turbine as intended, serves the purpose of extracting an amount of gas occurring in a condenser.

8. The method as claimed in claim 7, in which, during the shutting down of the steam turbine, a supply of sealing steam taking place by way of a system of lines is interrupted, whereupon dry air is sucked in by way of the system of lines.
